(19) United States
(12) Patent Application Publication
(10) Pub. No.: US 2019/0076977 A1
(43) Pub. Date: Mar. 14, 2019

(54) A SUPERFINISHING METHOD FOR A BEARING ROLLER, AND A SUPERFINISHING DEVICE FOR A BEARING ROLLER

(71) Applicant: NTN CORPORATION, Osaka (JP)

(72) Inventors: Kohei HIGASHI, Shizuoka (JP); Shinji FUSHIHARA, Shizuoka (JP); Akinori OTSUKA, Shizuoka (JP)

(73) Assignee: NTN CORPORATION, Osaka (JP)

(21) Appl. No.: 15/773,611

(22) PCT Filed: Oct. 27, 2016
(86) PCT No.: PCT/JP2016/081932

§ 371 Date: May 4, 2018

(30) Foreign Application Priority Data
Nov. 18, 2015 (JP) 2015-225635

(51) Int. Cl. B24B 5/24; F16C 33/36

(52) U.S. Cl. CPC B24B 5/245; B24B 5/042; F16C 33/366

(57) ABSTRACT

A superfinishing method for a bearing roller involves installation of a pair of parallel feed drums. The feed drums have guide thread surfaces each continuing in a spiral shape on an outer periphery, and each being driven to rotate about respective center axes. The feed drums through-feed a workpiece to be formed into a bearing roller while supporting and rotating the workpiece with the guide thread surfaces opposed to each other. The superfinishing method includes using a grinder to process an outer peripheral surface of the workpiece passing between the feed drums, varying a thread bottom angle of the guide thread surface based on positions along the feed drums in an axial direction, and superfinishing straight and logarithmic portions at both ends of the straight portion of a rolling surface of the bearing roller by one through-feed of the workpiece passing between the feed drums.

### TECHNICAL FIELD

The present invention relates to a superfinishing method and a superfinishing device for a rolling surface of a bearing roller having a logarithmic curve crowning.

### BACKGROUND ART

In general, a radially outer surface of a tapered roller to be used for a tapered roller bearing is subjected to superfinishing. Nowadays, there has been a demand for eliminating stress concentration on end portions of a roller (edge load) caused by misalignment of a tapered roller bearing. Therefore, there are many cases of employing a logarithmic curve crowning or a crowning with an arc having a complex curvature formed at each end portion of a rolling surface of a roller. Further, it is required that a rolling surface of the tapered roller to be used for the tapered roller bearing be superfinished. However, it has been difficult to perform superfinishing of crowning portions with high efficiency and high accuracy by the superfinishing having hitherto been employed. As technologies having been proposed to solve this problem, there are given Patent Document 1 and Patent Document 2.

### PRIOR ART DOCUMENTS

### Patent Documents

Patent Document 1: JP 56-121562 U
Patent Document 2: JP 2012-61571 A

### SUMMARY OF THE INVENTION

### Problems to be Solved by the Invention

According to the method of Patent Document 1, for superfinishing of crowning portions of a tapered roller, an angle of a guide thread surface of a feed drum serving as a support surface for the tapered roller varies on the inlet side and the outlet side. However, with this method, the logarithmic curve crowning or the crowning with an arc having a complex curvature at rolling surface end portions of the roller cannot be superfinished. Further, no focus is given on superfinishing an entire region of a rolling surface including the crowning portions with high efficiency and high accuracy.

According to the method of Patent Document 2, an axial center of a roller is inclined by multi-protrusion split threads of feed drums. However, with this method, a certain small crowning having a single curvature can be processed, but there is difficulty in stably superfinishing the logarithmic curve crowning or the crowning with an arc having a complex curvature at end portions of a rolling surface of a roller due to, for example, a problem of abrasion which occurs at the multi-protrusion split thread portions. Further, an entire region of the rolling surface including such logarithmic curve crowning portions cannot be continuously superfinished. Further, it is required that the split threads be individually processed. Therefore, productivity of the feed drums is considerably low.

In view of the above-mentioned problems, the present invention has an object to provide a superfinishing method and a superfinishing device for a bearing roller, which are capable of processing an entire region of a rolling surface including logarithmic curve crowning portions of the bearing roller with high efficiency and high accuracy.

### Solution to the Problems

As a result of various investigations conducted to achieve the above-mentioned object, the inventors of the present invention have arrived at a novel idea of varying a thread bottom angle of a guide thread surface of a feed drum from an entry side toward a discharge side and superfinishing an entire region of a rolling surface including logarithmic curve crowning portions of the bearing roller.

As technical measures to solve the above-mentioned problem, according to one embodiment of the present invention, there is provided a superfinishing method for a bearing roller, which involves installation of a pair of feed drums in parallel to each other, the pair of feed drums having guide thread surfaces each continue in a spiral shape on an outer periphery, and each being driven to rotate about respective center axes, the feed drums being configured to through-feed a workpiece that is to be formed into a bearing roller between the feed drums while supporting and rotating the workpiece with the guide thread surfaces opposed to each other, the superfinishing method including use of a grinder to process an outer peripheral surface of the workpiece passing between the feed drums, the superfinishing method comprising: varying a thread bottom angle of the guide thread surface in accordance with positions along the feed drums in an axial direction; and superfinishing a straight portion and logarithmic curve crowning portions at both ends of the straight portion of a rolling surface of the bearing roller by one through-feed of the workpiece passing between the feed drums.

Further, according to one embodiment of the present invention, there is provided a superfinishing device for a bearing roller, which involves installation of a pair of feed drums in parallel to each other, the pair of feed drums having guide thread surfaces that each continue in a spiral shape on an outer periphery, and each being driven to rotate about respective center axes, the feed drums being configured to through-feed a workpiece that is to be formed into a bearing roller between the feed drums while supporting and rotating the workpiece with the guide thread surfaces opposed to each other, the superfinishing device comprising a grinder configured to process an outer peripheral surface of the workpiece passing between the feed drums, wherein thread bottom angles of the guide thread surfaces of the pair of feed drums vary so as to correspond to shapes of a straight portion and logarithmic curve crowning portions at both ends of the straight portion of the rolling surface of the bearing roller.

With the above-mentioned configuration, the superfinishing method and the superfinishing device for a bearing roller which are capable of processing the entire region of the rolling surface including the logarithmic curve crowning portions of the bearing roller with high efficiency and high accuracy can be achieved. The logarithmic curve crowning implies a crowning having a logarithmic curve or a crowning approximate to a logarithmic curve with a plurality of arcs having different curvatures which are smoothly connected to one another. Further, the through-feeding implies feeding of allowing a workpiece to pass in an axial direction from an entry side to a discharge side of both feed drums.

An angle of the bottom surface of the above-mentioned guide thread surface continuously or stepwisely varies in accordance with positions along the feed drums in the axial direction. With this configuration, the entire region of the rolling surface of the bearing roller having the logarithmic curve crowning portions can be superfinished with one processing machine, thereby being capable of reducing manufacturing cost and improving productivity.

The above-mentioned bearing roller is a tapered roller or a cylindrical roller. With this, performance required for a tapered roller bearing or a cylindrical roller bearing being a mass-produced product is satisfied. Further, reduction in manufacturing cost and improvement in productivity can be achieved.

### Effects of the Invention

According to the present invention, a superfinishing method and a superfinishing device for a bearing roller, which are capable of processing an entire region of a rolling surface including logarithmic curve crowning portions of the bearing roller with high efficiency and high accuracy can be achieved.

### BRIEF DESCRIPTION OF DRAWINGS

FIG. 1 is a vertical sectional view for illustrating a tapered roller bearing into which a bearing roller processed by a superfinishing method and a superfinishing device according to one embodiment of the present invention is incorporated.

FIG. 2a is a front view of the tapered roller of FIG. 1.

FIG. 2b is an enlarged view of the portion A of FIG. 2a.

FIG. 3 is a plan view of the superfinishing device according to one embodiment of the present invention.

FIG. 4 is a plan view of the superfinishing device.

FIG. 5 is a cross-sectional view as seen in the direction indicated by the arrows of the line B-B of FIG. 4.

FIG. 6 is a view for illustrating a main part of a feed drum of the superfinishing device.

FIG. 7 is a view for illustrating a concept of an operation of performing superfinishing with the superfinishing device.

FIG. 8 is a view for illustrating a concept of an operation of performing superfinishing with the superfinishing device.

FIG. 9 is a view for illustrating a specific example of performing superfinishing with the superfinishing device.

FIG. 10 is a vertical sectional view for illustrating a cylindrical roller bearing into which a bearing roller processed by the superfinishing method and the superfinishing device according to one embodiment of the present invention is incorporated.

### EMBODIMENTS OF THE INVENTION

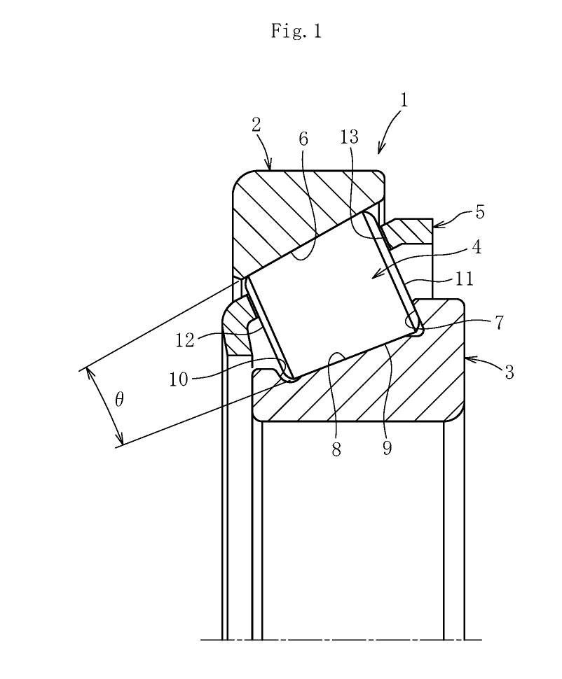

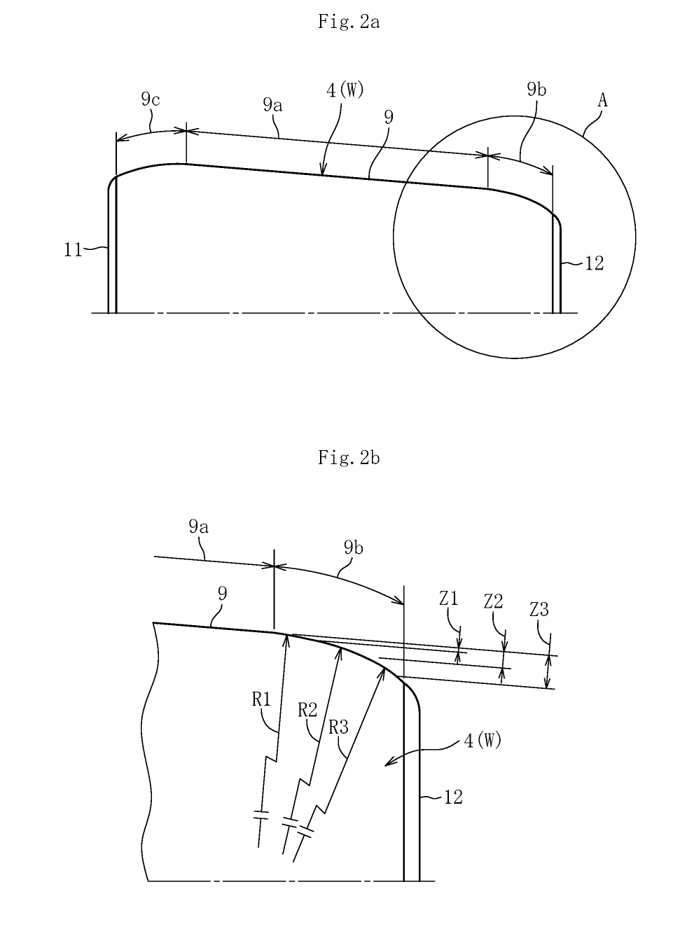

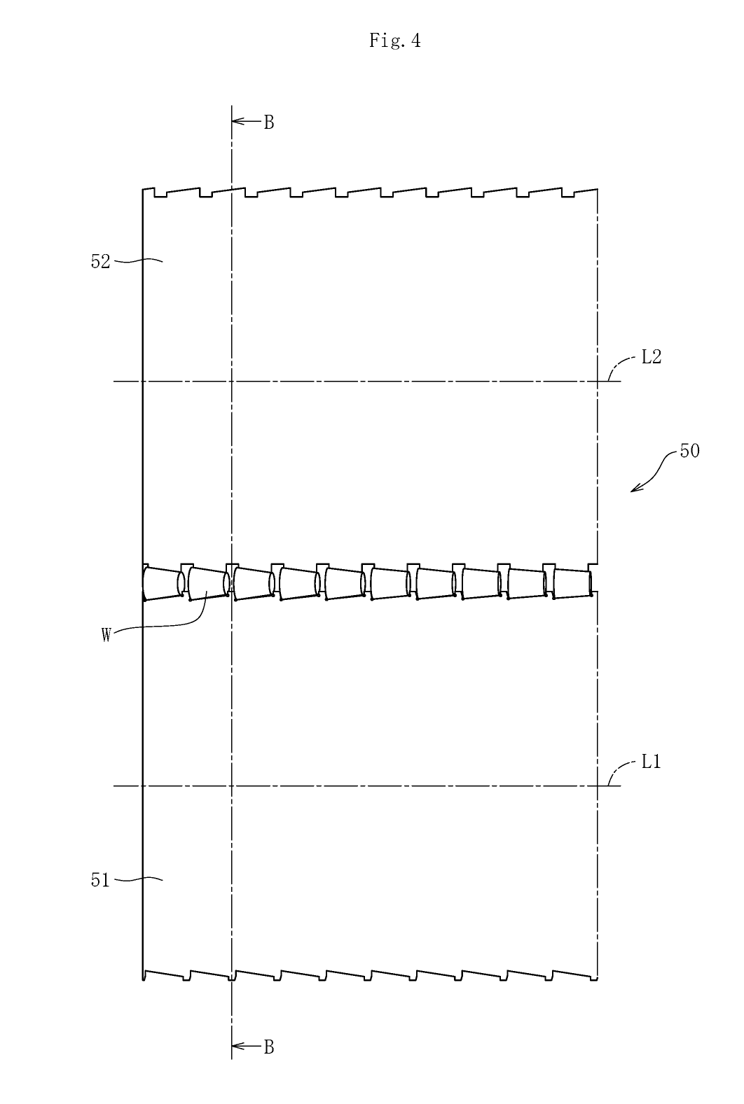

With reference to FIG. 1 to FIG. 9, descriptions are made of a superfinishing method according to one embodiment of the present invention and a superfinishing device according to one embodiment of the present invention. First, with reference to FIG. 1 and FIG. 2, description is made of a tapered roller bearing into which a bearing roller processed by the superfinishing method according to this embodiment and the superfinishing device according to this embodiment is incorporated.

FIG. 1 is a vertical sectional view for illustrating the tapered roller bearing. The tapered roller bearing 1 comprises an outer ring 2, an inner ring 3, tapered rollers 4, and a retainer 5. The outer ring 2 has a raceway surface 6 having a conical shape on an inner peripheral surface thereof. The inner ring 3 has a raceway surface 8 having a conical shape on an outer peripheral surface thereof. The raceway surface 8 has a large-collar surface 7 on a large-diameter side and a small-collar surface 10 on a small-diameter side. The tapered rollers 4 are arranged between the outer ring 2 and the inner ring 3. The tapered rollers 4 each have a rolling surface 9 having a conical shape on an outer peripheral surface thereof, and have a large end surface 11 and a small end surface 12. The rolling surface 9 has a cone angle θ. The retainer 5 receives a large number of tapered rollers 4 at given intervals in pockets 13 so that the tapered rollers 4 are freely rollable. A logarithmic curve crowning is formed on each of the large end surface 11 side and the small end surface 12 side of the rolling surface 9 of the tapered roller 4.

With reference to FIG. 2a and FIG. 2b, description is made of the logarithmic curve crowning formed on the rolling surface 9 of the tapered roller 4. FIG. 2a is a front view of the tapered roller 4, and is an illustration of an upper half from a center line. FIG. 2b is an enlarged view of the portion A of FIG. 2a. As illustrated in FIG. 2a, the rolling surface 9 of the tapered roller 4 comprises a straight portion 9a, a crowning portion 9b, and a crowning portion 9c. The straight portion 9a has a linear shape. The crowning portion 9b and the crowning portion 9c are formed so as to extend from both ends of the straight portion 9a in an axial direction. The crowning portion 9b is formed on the small end surface 12 side, and the crowning portion 9c is formed on the large end surface 11 side.

With reference to FIG. 2b, detailed description is made of the crowning portion 9b formed on the small end surface 12 side of the tapered roller 4. The crowning portion 9b has a complex arc shape which is formed by smoothly connecting three arcs having large curvature radii R1, R2, and R3 at the straight portion 9a. As drop amounts of the crowning portion 9b, there are defined a drop amount Z1 at a first gate, a middle drop amount Z2 at a second gate, and a maximum drop amount Z3 at a third gate, thereby forming a crowning shape approximate to a logarithmic curve. With this configuration, an edge load is avoided, thereby being capable of attaining even surface pressure distribution in the axial direction. The drop amount differs depending on a size or a model number, but is from about 20 μm to about 40 μm at maximum. The crowning portion 9c formed on the large end surface 11 side is similar to the crowning portion 9b, and hence description thereof is omitted.

The tapered roller 4 is manufactured by superfinishing a workpiece W described later. Thus, the tapered roller 4 is denoted also by the reference symbol W in FIG. 2a and FIG. 2b. The workpiece W before being superfinished is subjected to grinding at portions corresponding to the straight portion 9a and the crowning portions 9b and 9c of the rolling surface 9. However, not limited thereto, the portions of the workpiece W corresponding to the rolling surface 9 may be ground into a linear shape over an entire length, and the crowning portions may be omitted. In this case, the crowning portions are formed by superfinishing. With regard to the rolling surface 9, the straight portion 9a, and the crowning portions 9b and 9c of the tapered roller 4, in the following description of the workpiece W during the superfinishing, a portion of the outer peripheral surface of the workpiece W corresponding to the rolling surface 9 is referred to as “rolling surface 9 corresponding portion”. A portion corresponding to the straight portion 9a is referred to as “straight portion 9a corresponding portion”. A portion corresponding to the crowning portion 9b is referred to as “crowning portion 9b corresponding portion”. A portion corresponding to the crowning portion 9c is referred to as “crowning portion 9c corresponding portion”.

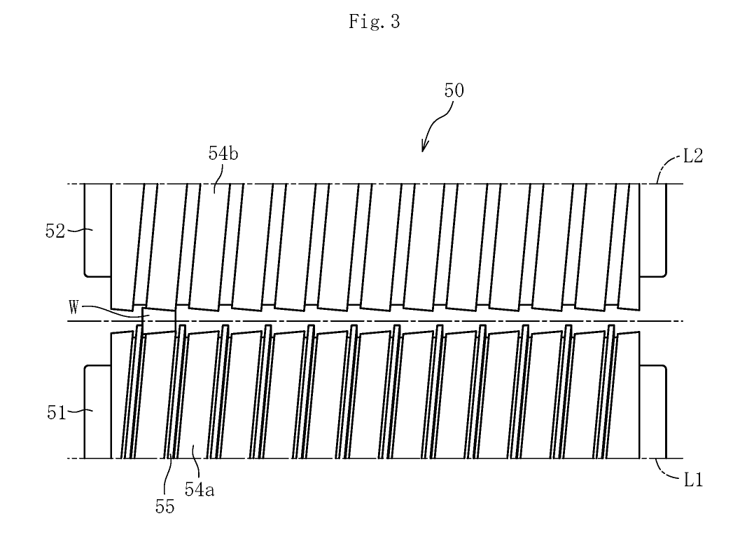

Next, with reference to FIG. 3 to FIG. 9, description is made of the superfinishing device according to one embodiment of the present invention. The following description also includes description of the superfinishing method according one embodiment of the present invention. With regard to the superfinishing device according to this embodiment, description is made of an example in which a rolling surface of the tapered roller is superfinished.

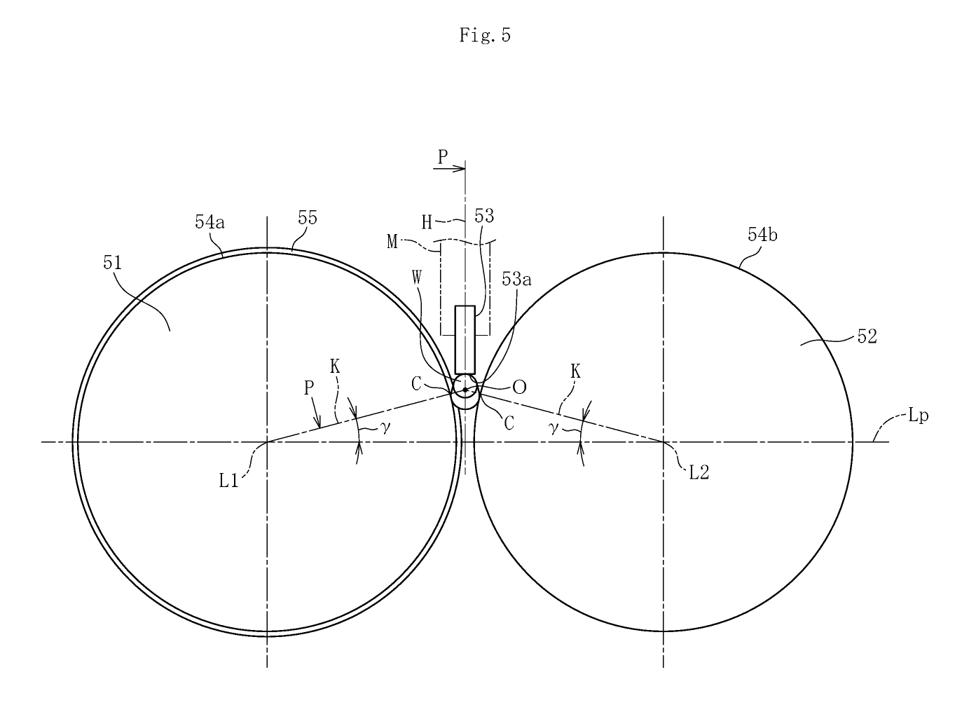

Description is made of a configuration of the superfinishing device. As illustrated in FIG. 3 to FIG. 5, the superfinishing device 50 mainly comprises a pair of feed drums 51 and 52 and grinders 53 (see FIG. 5). The feed drums 51 and 52 have guide thread surfaces 54a and 54b, which continue in a spiral shape, on respective outer peripheries. The feed drum 51 comprises flange portions 55 at end portions of the guide thread surface 54a. The feed drums 51 and 52 are driven to rotate about respective center axes L1 and L2. The pair of feed drums 51 and 52 are arranged in parallel with each other while being apart from each other at a predetermined interval. The feed drums 51 and 52 support and rotate the workpiece W with respective guide thread surfaces 54a and 54b opposed to each other, thereby causing the workpiece W to be through-fed between the feed drums 51 and 52.

The grinders 53 are configured to superfinish the workpiece W, which has been ground into a linear shape over an entire length of the rolling surface 9 corresponding portion, to thereby finish the tapered roller 4 illustrated in FIG. 2. As mentioned above, the rolling surface 9 of the tapered roller 4 comprises the straight portion 9a and the crowning portions 9b and 9c. Under a state in which a lower end edge portion 53a of the grinder 53 (see FIG. 5), which is a processing surface of the grinder 53, is held in abutment against the rolling surface 9 corresponding portion of the workpiece W, the workpiece W is rotated about its own axis and through-fed, thereby superfinishing the rolling surface 9 corresponding portion of the workpiece W.

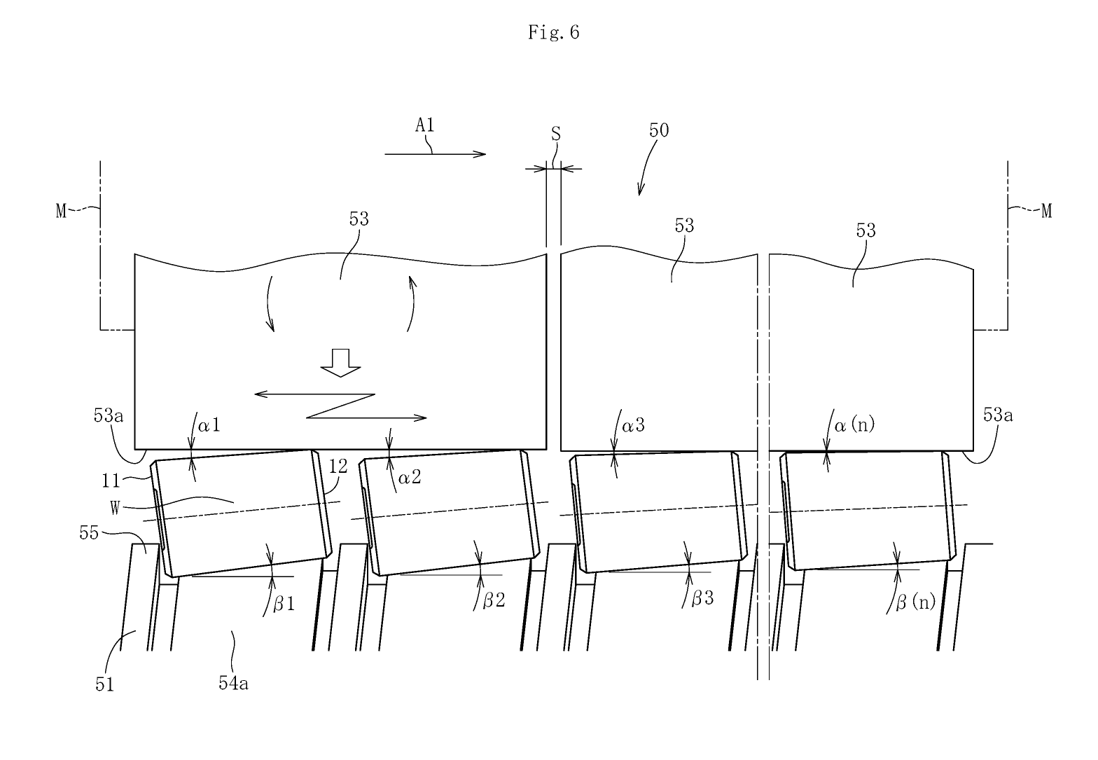

As illustrated in FIG. 5 and FIG. 6, as the grinders 53 in this example, so-called stick grinders each having a plate-like shape are used. The plurality of grinders 53 each having the plate-like shape are arrayed in parallel to respective center axes L1 and L2 of the feed drums 51 and 52. As illustrated in FIG. 5, the grinders 53 are arranged so that respective lower end edge portions 53a being respective processing surfaces of the grinders 53 having the plate-like shape are inserted between the feed drums 51 and 52.

As illustrated in FIG. 5 and FIG. 6, the plurality of grinders 53 are supported by a support member M. As illustrated in FIG. 6, each grinder 53 is rockable with respect to the support member M in parallel to the center axes L1 and L2 (see FIG. 5). Each grinder 53 being rockable is configured to superfinish the workpiece W, thereby forming the rolling surface 9 of the tapered roller 4, which comprises the straight portion 9a and the crowning portions 9b and 9c. In order to prevent interference with an adjacent grinder 53 at the time of rocking of the grinder 53, a gap S is formed between the grinders 53 and 53 (see FIG. 6). The workpiece W is conveyed under a state in which the crowning portion 9b corresponding portion of the workpiece W is held in abutment against the lower end edge portion 53a of the grinder 53, thereby causing the grinder 53 to rock and displace. In a case in which one workpiece W is focused, when the workpiece W is conveyed from an entry side to a discharge side of the feed drums 51 and 52, the workpiece W causes the grinder 53 to slightly rock and displace in a counterclockwise direction in FIG. 6 with respect to the feed drums 51 and 52, and the workpiece W is conveyed with inclination of the rolling surface 9 corresponding portion of the workpiece W with respect to the lower end edge portion 53a of the grinder 53 being the processing surface, thereby being capable of forming the crowning portion 9b having a small curvature (large curvature radius of, for example, 1,000 mm).

As illustrated in FIG. 3, the two feed drums 51 and 52 comprise the male-side feed drum 51 and the female-side feed drum 52. Of those feed drums 51 and 52, the guide thread surface 54a of the male-side feed drum 51 is partitioned with respect to an adjacent guide thread surface 54a by the flange portion 55 having a spiral shape. No flange portion is provided to the guide thread surface 54b of the female-side feed drum 52. As illustrated in FIG. 6, the feed drums 51 and 52 are rotated under a state in which the large end surface 11 of the workpiece W is held in abutment against the flange portion 55, thereby conveying the workpiece W from the entry side to the discharge side indicated by the arrow A1 with the small end surface 12 of the workpiece W being oriented forward (conveyance direction).

Next, with reference to FIG. 5 and FIG. 6, description is made of thread bottom angles of the guide thread surfaces 54a and 54b of the feed drums 51 and 52 and an inclination angle between the rolling surface 9 corresponding portion of the workpiece W and the lower end edge portion 53a of the grinder 53. As illustrated in FIG. 5, the workpiece W is held in abutment against the guide thread surfaces 54a and 54b of the two feed drums 51 and 52. A straight line connecting an abutment portion C of the workpiece W and the feed drum 51 to a center axis L1 of the feed drum 51 and a straight line connecting an abutment portion C of the workpiece W and the feed drum 52 to a center axis L2 of the feed drum 52 are denoted by the reference symbol K. An angle formed between each straight line K and a plane Lp including the center axes L1 and L2 of both the feed drums 51 and 52 is denoted by the reference symbol γ. The workpiece W has the large end surface 11 and the small end surface 12. Therefore, for convenience, the abutment portions C of the workpiece W with respect to the guide thread surfaces 54a and 54b of the feed drums 51 and 52 illustrated in FIG. 5 are portions at the center of the workpiece W in the axial direction, that is, portions at an average diameter, and an axial center O of the workpiece W at those portions is positioned on the straight lines K. A straight line which passes the axial center O of the workpiece W and a center of the grinder 53 is denoted by the reference symbol H.

FIG. 6 is a view for illustrating a part along the H-O-K line of FIG. 5 as seen in the direction P indicated by the arrows. Description is made of angles α and β of FIG. 6. On the plane including the straight line K and the center axis L1 of FIG. 5, an angle formed between a thread bottom of the guide thread surface 54a of the feed drum 51 and the center axis L1 is defined as the angle β. Further, on the plane including the straight line H of FIG. 5 and being parallel to the center axis L1, an angle formed between the lower end edge portion 53a of the grinder 53 and the rolling surface 9 corresponding portion of the workpiece W is defined as the angle α. As illustrated in FIG. 1, the rolling surface 9 of the tapered roller 4 has the cone angle θ. As illustrated in FIG. 5, the plane including the straight line K and the center axis L1 and the plane including the straight line H and being parallel to the center axis L1 forms an angle of (90°−γ). Such a geometrical relationship is given, and hence, in order to set the angle α, the angle β is determined in consideration of the cone angle θ and the angle of (90°−γ). When the angle β determined in such a manner is formed at the thread bottom of the guide thread surface 54a of the feed drum 51, the angle α is formed between the lower end edge portion 53a of the grinder 53 and the rolling surface 9 corresponding portion of the workpiece W.

In order to vary the angle α in the order of α1, α2, α3, . . . α(n) from the entry side to the discharge side in the conveyance direction so as to correspond to the shapes of the crowning portions 9b and 9c and the straight portion 9a (see FIG. 2a) of the rolling surface 9 of the tapered roller 4 as illustrated in FIG. 6, the angle β is formed so as to continuously or stepwisely vary in the order of β1, β2, β3, . . . β(n). In FIG. 6, the angles α1 to α3 correspond to regions in which the crowning portion 9b on the small end surface 12 side of the rolling surface 9 of the tapered roller 4 is superfinished, and the angle α(n) [α(n)=0°] corresponds to a region in which the straight portion 9a of the rolling surface 9 is superfinished.

Although not shown, the thread bottom angle β is set also to the guide thread surface 54b of the feed drum 52 similarly to the thread bottom angle β of the guide thread surface 54a of the feed drum 51.

The thread bottom surfaces of the guide thread surfaces 54a and 54b of the feed drums 51 and 52 are flat surfaces. Therefore, a contact width with respect to the outer peripheral surface of the workpiece W can be sufficiently secured, and the entire region of the rolling surface 9 comprising the straight portion 9a and the logarithmic curve crowning portions 9b and 9c formed at both ends of the straight portion 9a can be stably superfinished, thereby being capable of performing processing with high efficiency and high accuracy.

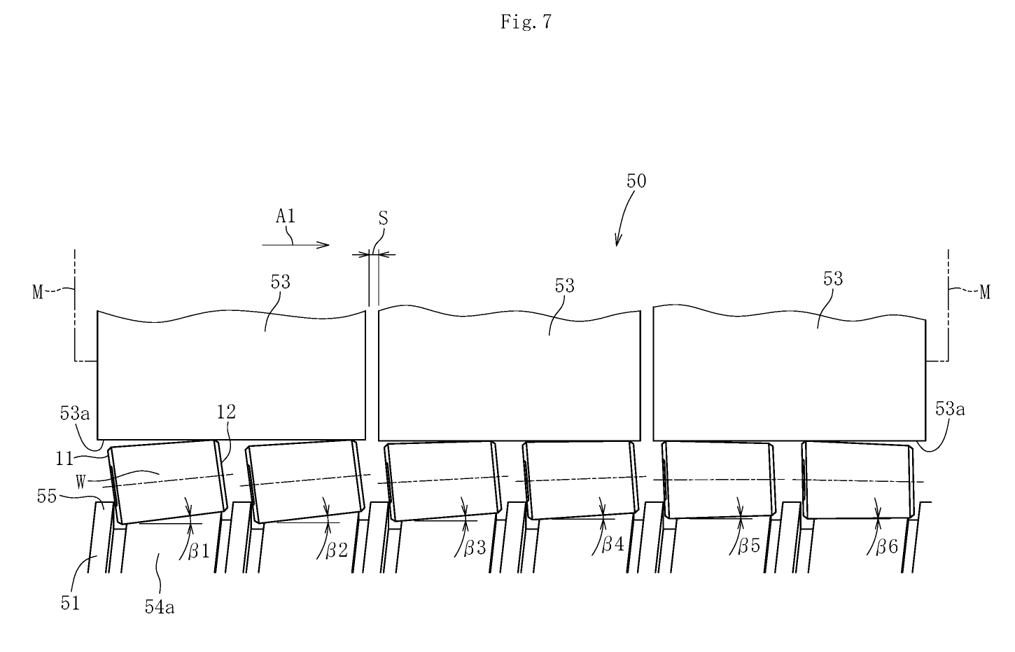

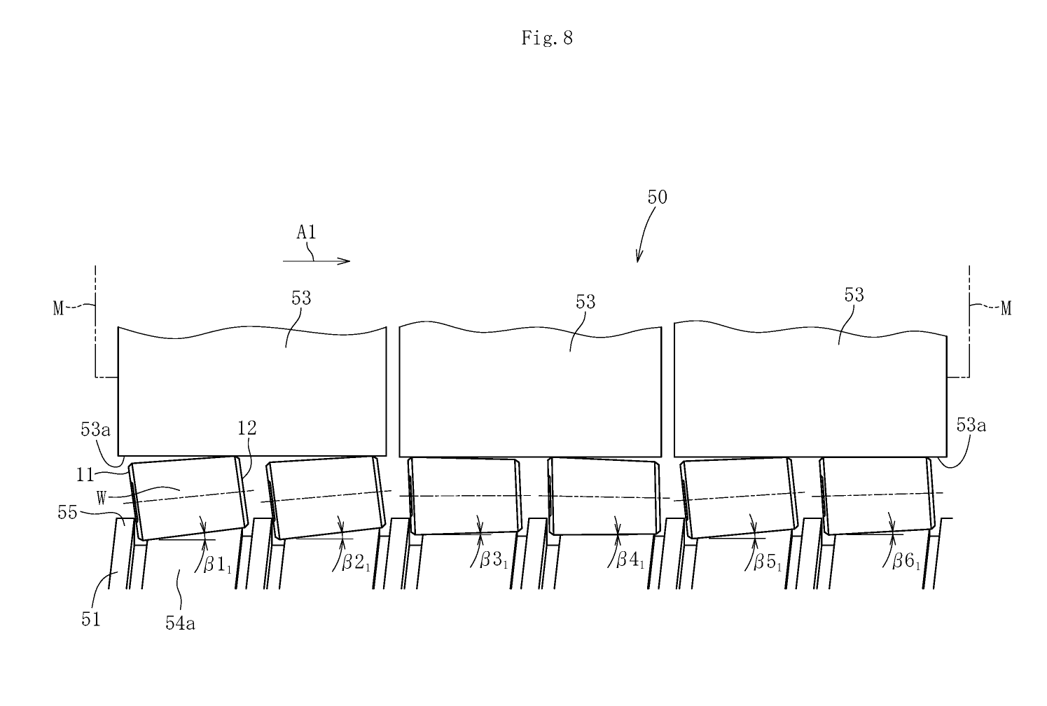

The configuration of the superfinishing device according to this embodiment is as described above. Next, description is made of an operation of the superfinishing device. First, with reference to FIG. 7 and FIG. 8, description is made of the concept of the operation of stepwisely varying the thread bottom angles β of the guide thread surfaces of the feed drums 51 and 52 from the entry side toward the discharge side in the conveyance direction of the workpiece W and superfinishing the crowning portion 9b corresponding portion, the crowning portion 9c corresponding portion, and the straight portion 9a corresponding portion of the rolling surface 9 corresponding portion of the workpiece W.

FIG. 7 is an illustration of a case in which superfinishing is performed for the crowning portion 9b corresponding portion on the small end surface 12 side of the rolling surface 9 corresponding portion of workpiece W, the straight portion 9a corresponding portion, and the crowning portion 9c corresponding portion on the large end surface 11 side in the stated order. In this case, as illustrated in FIG. 7, the thread bottom angle β of the guide thread surface 54a of the feed drum 51 is set in the order of β1, β2, β3, β4, β5, and β6 from the entry side to the discharge side in the conveyance direction. Superfinishing is sequentially performed for the crowning portion 9b corresponding portion on the small end surface 12 side, the straight portion 9a corresponding portion, and the crowning portion 9c corresponding portion on the large end surface 11 side in the stated order, thereby being capable of more smoothly connecting the straight portion 9a to the crowning portions 9b and 9c. However, the crowning portion 9c corresponding portion on the large end surface 11 side is superfinished after the superfinishing of the straight portion 9a, with the result that there is a fear of causing formation of grinding grain scratches on the straight portion 9a.

FIG. 8 is an illustration of a case in which superfinishing is performed for the crowning portion 9b corresponding portion on the small end surface 12 side of the rolling surface 9 corresponding portion of workpiece W, the crowning portion 9c corresponding portion on the large end surface 11 side, and the straight portion 9a corresponding portion in the stated order. In this case, as illustrated in FIG. 8, the thread bottom angle β of the guide thread surface 54a of the feed drum 51 is set in the order of β1₁, β2₁, β3₁, β4₁, β5₁, and β6₁ from the entry side to the discharge side in the conveyance direction. Through comparison of the thread bottom angle β with the case of FIG. 7, there are given β1₁=β1, β2₁=β2, β3₁=β5, β4₁=β6, β5₁=β3, and β6₁=β4. The straight portion 9a corresponding portion is superfinished at last, and hence the grinding grain scratches are less liable to be formed on the straight portion 9a.

Although illustration of the feed drum 52 is omitted also in FIG. 7 and FIG. 8, for the thread bottom angle of the guide thread surface 54b of the feed drum 52, the thread bottom angle which is the same as the thread bottom angle β of the guide thread surface 54a of the feed drum 51 in FIG. 7 and FIG. 8 is set.

When the workpiece W is through-fed from the entry side to the discharge side in the conveyance direction and is discharged from the superfinishing device 50, the workpiece W is formed into the tapered roller 4 being the bearing roller.

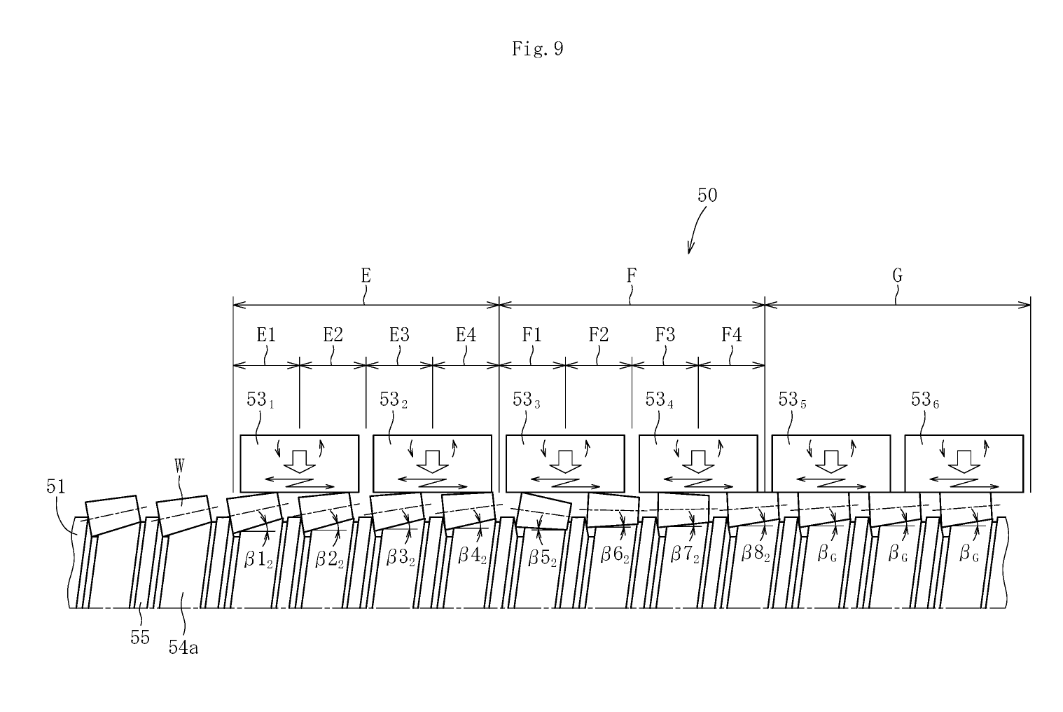

Next, with reference to FIG. 9, description is made of a specific example. Along the entire length of the feed drums 51 and 52 (not shown), six grinders 53₁ to 53₆ are prepared. The two grinders 53₁ and 53₂, which are provided in a section E on the entry side in the conveyance direction, are configured to superfinish the crowning portion 9b corresponding portion on the small end surface 12 side of the workpiece W. Next, the two grinders 53₃ and 53₄, which are provided in a section F at an intermediate portion, are configured to superfinish the crowning portion 9c corresponding portion on the large end surface 11 side. The two grinders 53₅ and 53₆, provided in a section G on the last discharge side, are configured to superfinish the straight portion 9a corresponding portion.

For the guide thread surface 54a of the feed drum 51 in the section E, there are set thread bottom angles corresponding to a plurality of arcs having different curvatures so as to form the logarithmic curve crowning shape of the crowning portion 9b on the small end surface 12 side. Specifically, for sub-sections E1, E2, E3, and E4 in the section E, there are set thread bottom angles β1₂, β2₂, β3₂, and β4₂, respectively. Similarly, for the guide thread surface 54a of the feed drum 51 in the section F, there are set thread bottom angles corresponding to a plurality of arcs having different curvatures so as to form the logarithmic curve crowning shape of the crowning portion 9c on the large end surface 11 side. Specifically, for sub-sections F1, F2, F3, and F4 in the section F, there are set thread bottom angles β5₂, β6₂, β7₂, and β8₂, respectively.

For the guide thread surface 54a of the feed drum 51 in the section G on the downstream side, there is set a thread bottom angle corresponding to the straight portion 9a, and the same thread bottom angle β_{G} is set for the entire region in the section G.

Connection portions are provided to the guide thread surface 54 at spaces of the sub-sections E1 to E4 and F1 to F4 and a space between the sub-section F4 and the section G, and the thread bottom angle β stepwisely varies.

Although not shown, the guide thread surface 54b of the feed drum 52 similarly has sections E to G and sub-sections E1 to E4 and F1 to F4, and thread bottom angles, which are the same as the thread bottom angles of the guide thread surface 54a of the feed drum 51, are set for the sub-sections E1 to E4 and F1 to F4 and the section G.

Axial distances of the sub-sections E1 to E4 and F1 to F4 are suitably set in accordance with the crowning shape. Further, the sections E to G are suitably set depending on a size and a model number of the workpiece W.

The specific example of the superfinishing device according to this embodiment has the configuration described above. Therefore, when the workpiece W is through-fed from the entry side to the discharge side in the conveyance direction, the entire region of the rolling surface 9 comprising the straight portion 9a and the crowning portions 9b and 9c is superfinished with high efficiency and high accuracy. When the workpiece W is through-fed from the entry side to the discharge side in the conveyance direction and discharged from the superfinishing device, the workpiece W is formed into the tapered roller 4 being the bearing roller illustrated in FIG. 2a and FIG. 2b. Thus, the entire region of the rolling surface of the bearing roller having the logarithmic curve crowning portions can be superfinished with one processing machine, thereby being capable of reducing manufacturing cost and improving productivity.

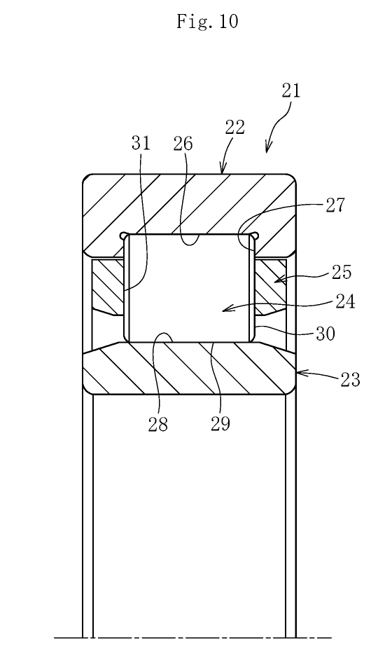

In this embodiment, description is made of the tapered roller 4 for the tapered roller bearing 1 as an example of the bearing roller to be subjected to processing. However, the bearing roller to be subjected to processing is not limited to the tapered roller, and may also be a cylindrical roller for a cylindrical roller bearing. As illustrated in FIG. 10, a cylindrical roller bearing 21 comprises an outer ring 22, an inner ring 23, cylindrical rollers 24, and a retainer 25. The outer ring 22 has a raceway surface 26 having a cylindrical shape on an inner peripheral surface thereof, and has collar surfaces 27 at both ends of the raceway surface 26. The inner ring 23 has a raceway surface 28 having a cylindrical shape on an outer peripheral surface thereof. The cylindrical rollers 24 are arranged between the outer ring 22 and the inner ring 23. The cylindrical rollers 24 each have a rolling surface 29 having a cylindrical shape on an outer peripheral surface thereof, and has end surfaces 30 at both ends. The retainer 25 receives a large number of cylindrical rollers 24 at given intervals in pockets 31 so that the cylindrical rollers 24 are freely rollable. Although not shown, a logarithmic curve crowning is formed at each of both end portions of the rolling surface 29 of the cylindrical roller 24. Details of the crowning shape are similar to the shape of the crowning shape of the tapered roller 1 described above, and hence the description of the tapered roller 1 is similarly adopted. Further, a superfinishing device and a superfinishing method are similar to those of the embodiment described above, and hence the description of the embodiment described above is similarly adopted, and description is omitted.

The present invention is not limited to the above-mentioned embodiments. As a matter of course, the present invention may be carried out in various modes without departing from the spirit of the present invention. The scope of the present invention is defined in claims, and encompasses equivalents described in claims and all changes within the scope of claims.

### DESCRIPTION OF REFERENCE SIGNS

1 tapered roller bearing
2 outer ring
3 inner ring
4 tapered roller
5 retainer
9 rolling surface
9a straight portion
9b crowning portion
9c crowning portion
21 cylindrical roller bearing
22 outer ring
23 inner ring
24 cylindrical roller
25 retainer
29 rolling surface
50 superfinishing device
51 feed drum
52 feed drum
53 grinder
53a lower end edge portion
54a guide thread surface
54b guide thread surface
L1 center axis
L2 center axis
W workpiece
α angle
β thread bottom angle
θ cone angle

1. A superfinishing method for a bearing roller, which involves installation of a pair of feed drums in parallel to each other, the pair of feed drums having guide thread surfaces each continue in a spiral shape on an outer periphery, and each being driven to rotate about respective center axes, the feed drums being configured to through-feed a workpiece that is to be formed into a bearing roller between the feed drums while supporting and rotating the workpiece with the guide thread surfaces opposed to each other, the superfinishing method including use of a grinder to process an outer peripheral surface of the workpiece passing between the feed drums, the superfinishing method comprising:
varying a thread bottom angle of the guide thread surface in accordance with positions along the feed drums in an axial direction; and
superfinishing a straight portion and logarithmic curve crowning portions at both ends of the straight portion of a rolling surface of the bearing roller by one through-feed of the workpiece passing between the feed drums.

2. The superfinishing method for a bearing roller according to claim 1, wherein the thread bottom angle of the guide thread surface continuously or stepwisely varies in accordance with positions along the feed drum in the axial direction.

3. The superfinishing method for a bearing roller according to claim 1, wherein the bearing roller comprises a tapered roller.

4. The superfinishing method for a bearing roller according to claim 1, wherein the bearing roller comprises a cylindrical roller.

5. A superfinishing device for a bearing roller, which involves installation of a pair of feed drums in parallel to each other, the pair of feed drums having guide thread surfaces each continue in a spiral shape on an outer periphery, and each being driven to rotate about respective center axes, the feed drums being configured to through-feed a workpiece that is to be formed into a bearing roller between the feed drums while supporting and rotating the workpiece with the guide thread surfaces opposed to each other, the superfinishing device comprising a grinder configured to process an outer peripheral surface of the workpiece passing between the feed drums,
wherein thread bottom angles of the guide thread surfaces of the pair of feed drums vary so as to correspond to shapes of a straight portion and logarithmic curve crowning portions at both ends of the straight portion of the rolling surface of the bearing roller.

6. The superfinishing device for a bearing roller according to claim 5, wherein the thread bottom angles of the guide thread surfaces continuously or stepwisely vary in accordance with positions along the feed drums in the axial direction.

7. The superfinishing method for a bearing roller according to claim 2, wherein the bearing roller comprises a tapered roller.

8. The superfinishing method for a bearing roller according to claim 2, wherein the bearing roller comprises a cylindrical roller.
